(19) United States
(12) Patent Application Publication
(10) Pub. No.: US 2008/0021845 A1
(43) Pub. Date: Jan. 24, 2008

(54) Method of Providing Trading Data

(76) Inventors: Timothy Morge, Aurora, IL (US); Dro Kholamian, Barrington Hills, IL (US)

Correspondence Address: CARDINAL LAW GROUP, Suite 2000, 1603 Orrington Avenue, Evanston, IL, 60201, US

(21) Appl. No.: 11/683,276

(22) Filed: Mar. 7, 2007

Related U.S. Application Data
(60) Provisional application No. 60/807,772, filed on Jul. 19, 2006.

(51) Int. Cl. G06Q 40/00; G06N 5/00

(52) U.S. Cl. 705/36 R; 706/50

(57) ABSTRACT

A method of providing trading data includes receiving at least one expert trading information request from a user, the expert trading information request associated with at least one expert and a service period and determining at least one real time expert trading parameter associated with the expert based on the request, the expert parameter including a financial instrument identity and a time span. The method further includes providing the determined expert parameter to the user in a continuous delivery fashion during the service period.

### RELATED APPLICATIONS

This is a non-provisional application claiming the benefit of U.S. Provisional Patent Application 60/807,772 filed on Jul. 19, 2006, the entirety of which is hereby incorporated by reference.

### FIELD OF INVENTION

The present invention generally relates to trading financial instruments. More specifically, the invention relates to providing information relating to trading financial instruments.

### BACKGROUND OF THE INVENTION

Financial instruments are traded on public exchanges, and many traders attempt to profit on changes in the selling prices of the financial instruments. Financial instruments include stocks, bonds, commodities, derivatives, swaps, options, futures, and any other instrument traded on a financial exchange. Some traders utilize a set of strategies based on historical prices to predict potential future price movements. These strategies are collectively known as technical analysis.

The technical analyst bases trading decisions on charts. The chart illustrates historical prices for a particular commodity over a time span. The time span can be as long as hundreds of years, or as short as minutes or less. As historical prices can be analyzed in many ways, many technical analysis techniques have been used. Learning to use these techniques is desirable to many traders, yet the training can be difficult to master and ongoing lessons are often desired by students. Typically, charts are displayed with the time line on the horizontal or x axis, and price information displayed on the vertical or y-axis.

To date, lessons have generally been offered by experts in a particular technical analysis methodology, and offered in classrooms or textbooks. Both suffer from undesired latency between the market conditions being analyzed and the students' exposure to the technique in light of the market conditions. Other solutions have been premised on email or snail mail updates alerting students or users to an area that the expert is reviewing or considers ripe for trading opportunities.

In addition to students, many traders desire to determine what other traders are buying or selling, or considering buying or selling. Thus, many experienced traders consult the teachings of experts to determine trading opportunities that may have been otherwise overlooked or insufficiently considered. While actual trading data is difficult to secure for most traders, knowledge of a respected traders trading strategy can be valuable.

It is therefore a challenge to develop a method to provide trading data to overcome these, and other, disadvantages.

### SUMMARY OF THE INVENTION

A first aspect of the invention provides a method of providing trading data that includes receiving at least one expert trading information request from a user, the expert trading information request associated with at least one expert and a service period and determining at least one real time expert trading parameter associated with the expert based on the request, the expert parameter including a financial instrument identity and a time span. The method further includes providing the determined expert parameter to the user in a continuous delivery fashion during the service period.

A second aspect of the invention provides a method for providing trading data. This method includes determining at least one real time expert trading parameter including a financial instrument identity and a time span, associating the determined at least one real time expert trading parameter with at least one expert, and receiving at least one expert trading information request from a user, the expert trading information request associated with at least one expert and a service period. The method further includes determining an authorization status for the user responsive to receiving the expert trading information request and providing the determined expert parameter to the user in a continuous delivery fashion during the service period.

A third aspect of the invention provides a computer readable medium including computer readable code for providing trading data. The medium includes computer readable code for receiving at least one expert trading information request from a user, the expert trading information request associated with at least one expert and a service period and computer readable code for determining at least one real time expert trading parameter associated with the expert based on the request, the expert parameter including a financial instrument identity and a time span. The medium further includes computer readable code for providing the determined expert parameter to the user in a continuous delivery fashion during the service period.

The foregoing embodiment and other embodiments, objects, and aspects as well as features and advantages of the present invention will become further apparent from the following detailed description of various embodiments of the present invention. The detailed description and drawings are merely illustrative of the present invention, rather than limiting the scope of the present invention being defined by the appended claims and equivalents thereof.

### BRIEF DESCRIPTION OF THE DRAWINGS

FIG. 1 illustrates one embodiment of a method for providing trading data, in accordance with one aspect of the invention;

FIG. 2 illustrates one embodiment of a method for providing trading data, in accordance with one aspect of the invention;

FIG. 3 illustrates one embodiment of a method for providing trading data, in accordance with one aspect of the invention;

FIG. 4 illustrates one embodiment of a method for providing trading data, in accordance with one aspect of the invention.

FIG. 5 illustrates an embodiment of method for providing trading data, in accordance with one aspect of the invention;

FIG. 6 illustrates one embodiment of a system for providing trading data, in accordance with one aspect of the invention; and

FIG. 7 illustrates an exemplary chart of trading data, for use with one aspect of the invention.

### DETAILED DESCRIPTION OF THE PRESENT INVENTION

FIG. 1 illustrates one aspect of a method 100 for providing trading information in accordance with one embodiment of the invention. Method 100 begins at step 110 by receiving an expert trading information request from a user. The expert trading information request is associated with at least one expert and a service period. The expert trading information request is received at a central location, such as a server or other communications center. In one embodiment, the expert trading information request is received via a packet data network, such as the Internet, an intranet, LAN or WAN. The expert trading information request can be received with a wired connection, or via a wireless connection, such as a connection using a FCC Part 13 protocol such as Bluetooth®, or an 802.11 protocol. The user can be any person or entity requesting trading data via an expert trading information request. As used herein, the term ‘expert’ means any person or entity that grants access to trading information used by the person or entity in real time. The service period can be any time span for receiving the expert trading information, from a short period to an open-ended period. For example, the service period can be measured in seconds, minutes, hours, days, months, years, or any appropriate measure.

After receiving the expert trading information request, method 100 determines at least one real time expert trading parameter associated with the expert at step 120. The expert trading parameter includes a financial instrument identity and a time span. The financial instrument identity is data indicative of a financial instrument under consideration by the expert. The financial instrument identity can relate to any traded instrument, such as stocks, bonds, derivatives, commodities, currencies, options, futures, swaps, or the like. For example, the financial instrument identity can be a stock ticker name, such as MSFT for Microsoft Corporation, F for Ford Company, or the like. The time span is a length of time that is currently under consideration by the expert.

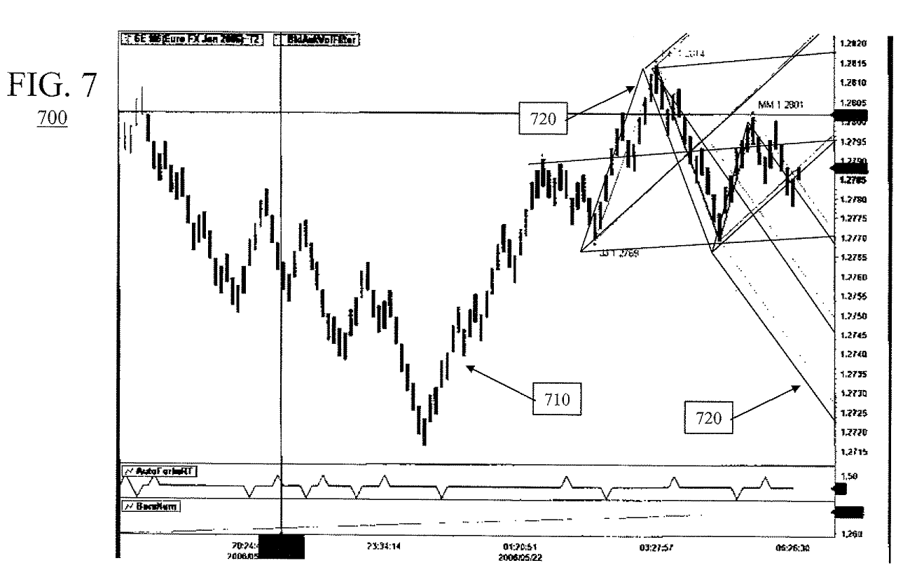

During step 120, the expert is monitoring a chart illustrative of price data for a financial instrument over a time span. An exemplary chart is illustrated in FIG. 7 at 700. The exemplary chart 700 illustrates pricing data for the Euro over a 24-hour time span on May 20-21, 2006. The chart is displayed based on price data for a determined period of time. The period of time can be historical, with the most recent data not current, or the period of time can be current, with the most recent price data representative of a recent price with latency responsive to system configuration and demands. The chart is also displayed based on use of technical analysis techniques. Technical analysis techniques are methods and techniques for analyzing price data in an effort to determine future price movements. Technical analysis techniques are known, and include candlesticks, Fibonacci, mean line, price bars, and the like. Each technical analysis technique overlays graphical information, such as a line, over price data or illustrates the price information graphically. Some technical analysis techniques color code pricing information, while other technical analysis techniques utilize bar charts or other graphical tools. Thus, certain technical analysis techniques illustrate rising prices with a green bar, or falling prices with a red bar. The length of the bar is also a source of information, such as volume, in certain technical analysis techniques. In one embodiment, the technical analysis technique is associated with an expert. Certain experts are known as proponents of particular technical analysis techniques.

The determined expert parameter is provided to the user in a continuous delivery fashion during the service period during step 130. A continuous delivery fashion means that the determined expert parameter is provided in substantially real time. In one embodiment, continuous delivery fashion is obtained using a streaming data connection over a packet data network. In another embodiment, continuous delivery fashion is obtained using a plurality of data calls with predetermined latency between each of the plurality of data calls.

Execution of method 100 occurs when an expert is monitoring a particular chart. The settings for the particular chart are sent to a central location, and these settings are then provided to a user. In a preferred embodiment, actual trading information, such as trade orders or executions by the expert, are not provided to the user, although such activities are contemplated and within the scope of this disclosure. In addition, real time changes to the chart made by the expert, such as changes in financial instruments or chart settings, are also sent to the central location and provided to the user, substantially in real time.

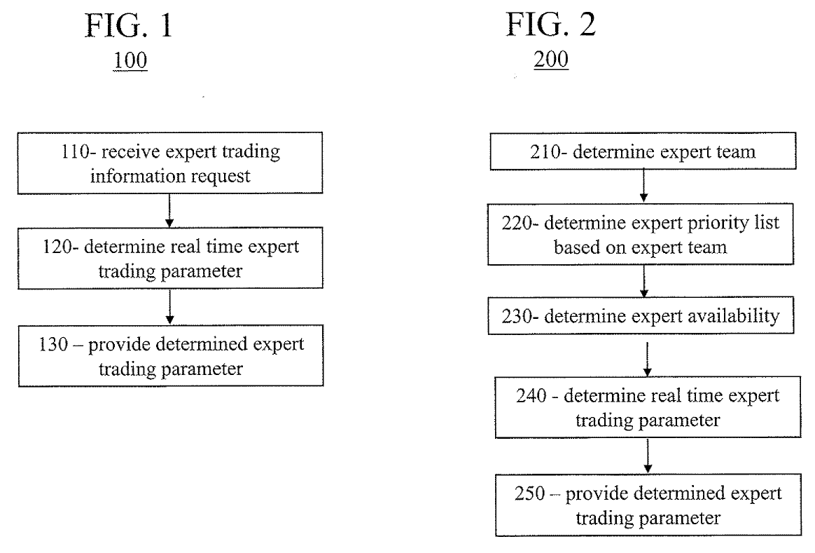

FIG. 2 illustrates one embodiment of another method 200 for providing trading data in accordance with another aspect of the invention. Method 200 begins by determining an expert team including a plurality of experts at step 210. The expert team can include experts associated with a particular technical analysis technique, a particular employer, a particular trading desk, particular security, or the like. Alternatively, the experts within the expert team need not have any relation to each other, with the exception of inclusion in an expert team. In one embodiment, the expert team is determined by receiving an expert team list from a user.

Method 200 continues at step 220 by determining an expert priority list based on the expert team. The expert priority list ranks each expert in accordance with a preference ranking. In one embodiment, the most preferred expert (i.e. highest preference ranking) is listed first, while in alternate embodiments, the most preferred expert is listed last. The preference ranking can be based on user preferences, prior expert recommendations, user recommendations, expert employment, association with a particular technical analysis technique, or the like. Alternatively, and/or additionally, preference ranking can be based on geographical proximity, financial instrument, time span, or the like. The preference ranking is determined in response to user preferences, in one embodiment. In another embodiment, the preference ranking is determined at the central server. In yet another embodiment, the preference ranking is based on expert input.

Having determined the expert priority list, method 200 determines expert availability for the expert with the highest ranking at step 230. Expert availability, as used herein, refers to whether a particular expert is consulting a chart at a particular time. For example, users desiring to consult a vacationing expert can, in certain embodiments, be redirected to another expert or provided trading data from an alternate expert.

Method 200 continues to determine at least one expert trading parameter associated with the highest ranking expert based on the determined expert availability at step 240, and provide the determined expert trading parameter to the user at step 250. Steps 240 and 250 are implemented, in one embodiment, in a similar fashion as steps 120 and 130.

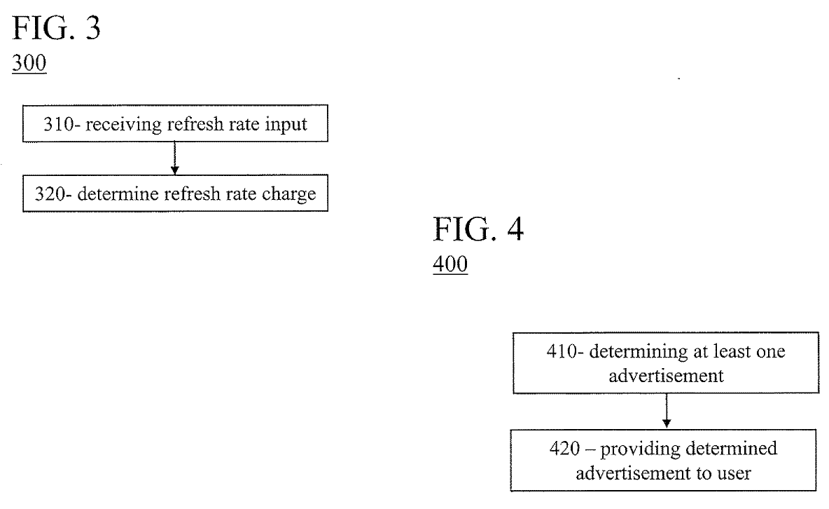

FIG. 3 illustrates one embodiment of a method 300 for providing trading data in accordance with one aspect of the invention. Method 300 begins at 310 by receiving a refresh rate input. In one embodiment, the refresh rate input is received at the central location from a user via a packet data network. A refresh rate input is a data input indicative of whether the user will receive a streaming connection, or alternatively, whether the user will issue a series of data requests (such as a HTTP pull) to receive the trading data from the expert. In addition, in the event of a non-streaming connection, the refresh rate input is associated with a latency or iteration rate reflective of the frequency for the data requests. For example, a user can request that the trading data is refreshed each second, each minute, each hour, each trading data change, or the like. The refresh can be accomplished via any appropriate technique, such as HTTP pull, RSS or Atom feed, or the like.

At step 320, the central location determines a refresh rate charge based on the selected refresh rate. For example, a streaming connection features a higher subscription price than an hourly refresh. In one example, method 300 further requires receipt of the refresh rate charge for the service period prior to providing trading data. In other examples, trading data is supplied to the user on a trial basis, or on a billed basis such that the trading data is supplied prior to receiving payment. In yet another example, the refresh rate charge is on an as-refreshed charge such that the trading data is supplied responsive to a refresh request from a user and the user is charged for each refresh request.

FIG. 4 illustrates another embodiment of a method 400 for providing trading data in accordance with another aspect of the invention. Method 400 begins at 410 by determining at least one advertisement, and continues at step 420 by providing the at least one determined advertisement to the user. In one example, the advertisement is provided to the user with the trading data. In another example, the subject matter of the advertisement is screened to select advertisements based on the trading data. In another example, the advertisement is selected to ensure that the subject of the advertisement does not compete with the provided trading data. In yet another embodiment, the advertisement is selected based on words contained within the advertisement and based on the underlying financial instrument, expert, or expert team.

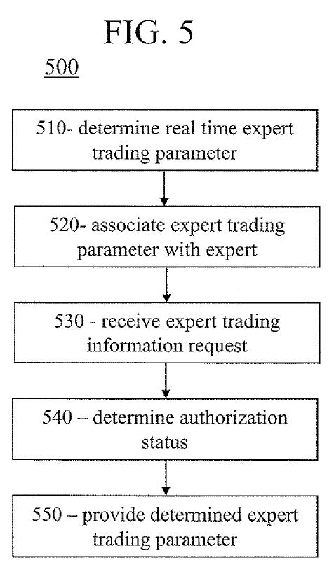

FIG. 5 illustrates one embodiment of a method 500 for providing trading data in accordance with another aspect of the invention. Method 500 begins at 510 by determining a real time expert trading parameter. The real time expert trading parameter is determined at a central location from an expert trading station (such as a PC or other trading device) by opening a connection between the trading station and central location. The connection can be a streaming connection or a series of connections opened responsive to data pulls, such as a series of HTTP calls. The expert trading parameter includes a financial instrument identity and a time span.

The expert trading parameter is then associated with at least one expert at step 520. After receiving the expert trading parameter and associating the expert trading parameter with an expert, the central location receives at least one expert trading information request from a user at step 530. The expert trading information request is associated with at least one expert and a service period.

Based on the received expert trading information request, the central location determines an authorization status for the user at step 540. The authorization status relates to whether a particular user is authorized to receive the requested expert trading information request. Authorization can refer to a subscription to the services provided by the central location, a subscription to the particular expert, a subscription to the particular expert team, or the like. In addition, in one embodiment, the authorization status includes an association with a refresh rate or streaming connection. In another embodiment, the authorization status includes a terminal date after which the authorization is no longer valid. In an embodiment, the terminal date is transmitted to the user so that the user will no longer have access to requested data after the terminal date, and also to enable the user to arrange for authorization after the terminal date.

Based on the authorization status, the central location then provides the determined expert trading parameter to the user in a continuous delivery fashion at step 550. As above, the continuous delivery fashion can be implemented via a streaming connection wherein a real time connection is opened between the user and central location or with a series of information requests with a predetermined latency.

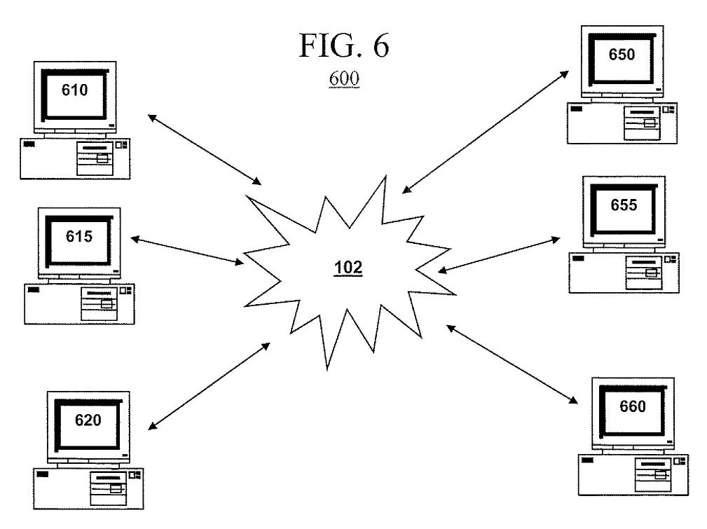

FIG. 6 illustrates a sample network 600 including a plurality of users 610, 615, 620 and a plurality of experts 650, 655, 660 connected via central location 102. Experts 650, 655, 660 are illustrated as a computer, although the expert can communicate with the central location via any appropriate device, including computers, cell phones, personal digital assistants, laptops, and the like. Users 610, 615, 620 are illustrated as a computer, although the expert can communicate with the central location via any appropriate device, including computers, cell phones, personal digital assistants, laptops, and the like. Central location 102 can be implemented as a server or server family and can be geographically concentrated or geographically dispersed. Thus, central location 102 can be implemented as, for example, a server farm or a peer-to-peer network. In another embodiment, historical records of expert activity can be stored and accessed using a bittorrent protocol. In one embodiment, central location includes access to real time prices for each financial instrument traded on an open market.

FIG. 7 illustrates an exemplary chart illustrating expert trading parameters in accordance with one aspect of the invention at 700. Chart 700 represents price movements of the Euro over a 24-hour service period during May 2006. As shown, the price bars 710 illustrate pricing data graphically, and include trading parameters illustrated as technical analysis lines 720. Technical analysis lines 720 are any lines overlaid upon a chart responsive to the teachings of a particular form of technical analysis. As illustrated, technical analysis lines 720 illustrate a mean line chart for the Euro during a subset of the particular service period. Thus, using the teachings of the current disclosure, in the event that an expert were reviewing FIG. 7, any user would be able to also see FIG. 7, and see FIG. 7 in real time. In the event that the expert then changed the parameters for the chart, such as by changing the service period or changing the underlying financial instrument, such a change would then be implemented for the user, in substantially real time in continuous delivery fashion. Traders are acquainted with many techniques for technical analysis, each of which can be adapted to be used within the scope of this disclosure.

In another embodiment, a user who receives expert trading parameters from a plurality of experts can alternate between experts. The user can press a button to alternate between experts, or select an available expert from a menu or list. In another embodiment, the user alternates between experts based on the financial instrument identity, such that if an expert changes financial instruments, the user switches to a different expert viewing the same financial instrument. In yet another embodiment, the user switches between experts with a predetermined rate. For example, a user can alternate between experts every 30 seconds, every 5 minutes, or the like. The experts can be selected from all experts participating with the central location, or a subset. The subset can be determined by the experts themselves, the user, or the central location.

In another embodiment, metadata underlying the chart being viewed by an expert is harvested or pulled from the expert. This metadata is received via a networked connection, such as the Internet. The metadata includes indicators for financial instrument identity, price bar types, price bar sizes, and a service period. Based on receiving the metadata, the metadata is then distributed to at least one user by a central location and displayed at a user trading station on a chart.

In one embodiment, the expert trading parameters are distributed to users using ESIGNAL®. In one embodiment, the expert trading parameters are distributed to users using TRADESTATION®. In one embodiment, the expert trading parameters are distributed to users using NEOTICKER®. In one embodiment, the expert trading parameters are distributed to users using CQC. In one embodiment, the expert trading parameters are distributed to users using Ensign. In one embodiment, the expert trading parameters are platform independent.

In another embodiment, the central location can determine an expert based on an expert request input from a user. For example, the user can request experts based on financial instruments and/or technical analysis techniques. Thus, in an embodiment, a user can request to see charts being viewed by experts trading MSFT. In another embodiment, a user can request to see charts being viewed by experts in median line trading techniques. Further, in other embodiments, the user can request to see charts viewed by experts monitoring MSFT using median line technical analysis techniques. The experts can be determined by the central location, and a list provided to the user for expert selection. In addition, the list can include advertisements for, or associations to advertisements for, experts related to the expert request input. In some embodiments, trial authorizations are available, such that a user can secure free access to expert trading information for a predetermined span of time. In another embodiment, the central location ranks experts based on a number of subscribers and presents the experts with the greatest number of subscribers. In other embodiments, experts can affect their ranking with payments to the central location to boost rankings.

In addition, in other embodiments, the user connects directly to the expert without use of a central location. The connection can be made directly, or with the assistance of a central location. In embodiments that feature a central location facilitated connection, the central location can open a user connection between the user and the central location and an expert connection between the expert and the central location, and then redirect each of the user connection and expert connection to a single connection between the user and expert.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

We claim:

1. A method of providing trading data, the method comprising:
receiving at least one expert trading information request from a user, the expert trading information request associated with at least one expert and a service period;
determining at least one real time expert trading parameter associated with the expert based on the request, the expert parameter including a financial instrument identity and a time span; and
providing the determined expert parameter to the user in a continuous delivery fashion during the service period.

2. The method of claim 1 further comprising:
determining at least one expert team, the expert team including a plurality of experts,
determining at least one real time expert trading parameter associated with each expert within the expert team based on the request, the expert parameter including a financial instrument identity and a time span; and
providing each determined expert parameter for each expert within the expert team to the user in a continuous delivery fashion during the service period.

3. The method of claim 1 further comprising:
determining at least one expert team, the expert team including a plurality of experts,
determining an expert priority list, the expert priority list ranking each expert in accordance with a preference ranking;
determining expert availability for the expert with the highest ranking;
determining at least one real time expert trading parameter associated with the highest ranking expert based on the determined expert availability within the expert team based on the request; and
providing each determined expert parameter for the determined highest ranking expert within the expert team to the user in a continuous delivery fashion during the service period.

4. The method of claim 1 further comprising:
receiving a refresh rate input from the user; and
determining a refresh rate charge based on the refresh rate input.

5. The method of claim 1 further comprising:
determining an activity state of the expert.

6. The method of claim 1 wherein the expert trading parameter includes at least one technical analysis technique identifier and at least one pricing parameter.

7. The method of claim 6 wherein the at least one technical analysis technique identifier is associated with the expert.

8. The method of claim 6 wherein the at least one technical analysis technique identifier is selected from the group consisting of candlesticks, mean line, moving averages, Eliot waves, and Fibonacci sequences.

9. The method of claim 6 wherein the at least one pricing parameter is selected from the group consisting of symbol, price bar type, price bar size, time.

10. The method of claim 6 wherein the at least one pricing parameter is a price bar defined by open price, close price, high price, and low price.

11. The method of claim 1 wherein the at least one expert trading request is received via a packet data network, and wherein the determined expert parameter is provided to the user via a packet data network.

12. The method of claim 1 wherein the continuous delivery fashion comprises opening a real time connection with the user and wherein the determined expert parameter is streamed to the user.

13. The method of claim 1 wherein the continuous delivery fashion comprises a series of information requests with a predetermined latency.

14. The method of claim 13 wherein the latency is determined based on a subscription status of the user.

15. The method of claim 1 further comprising:
determining at least one advertisement; and
providing the determined advertisement to the user.

16. A method of providing trading data, the method comprising:
determining at least one real time expert trading parameter including a financial instrument identity and a time span;
associating the determined at least one real time expert trading parameter with at least one expert;
receiving at least one expert trading information request from a user, the expert trading information request associated with at least one expert and a service period;
determining an authorization status for the user responsive to receiving the expert trading information request; and
providing the determined expert trading parameter to the user in a continuous delivery fashion during the service period based on the authorization status.

17. The method of claim 16 wherein the continuous delivery fashion comprises opening a real time connection with the user and wherein the determined expert parameter is streamed to the user.

18. The method of claim 16 wherein the continuous delivery fashion comprises a series of information requests with a predetermined latency.

19. A computer readable medium including computer readable code for providing trading data, the medium comprising:
computer readable code for receiving at least one expert trading information request from a user, the expert trading information request associated with at least one expert and a service period;
computer readable code for determining at least one real time expert trading parameter associated with the expert based on the request, the expert parameter including a financial instrument identity and a time span; and
computer readable code for providing the determined expert parameter to the user in a continuous delivery fashion during the service period.

20. The medium of claim 19 further comprising:
means for receiving a refresh rate input from the user; and
means for determining a refresh rate charge based on the refresh rate input.
